(19) United States
(12) Patent Application Publication
(10) Pub. No.: US 2006/0187212 A1
(43) Pub. Date: Aug. 24, 2006

(54) User interface apparatus and method

(75) Inventors: Sang-Yong Park, Suwon-si (KR); Seung-Gun Park, Yongin-si (KR); Sang-Hyuk Lee, Gunpo-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/361,720

(22) Filed: Feb. 24, 2006

(30) Foreign Application Priority Data
Feb. 24, 2005 (KR) 15521/2005

(51) Int. Cl. G09G 5/00

(52) U.S. Cl. 345/169

(57) ABSTRACT

A user interface apparatus comprises a plurality of key buttons, and a plurality of touchpad pieces, each located under an associated key button and situated such that a touch of an associated key button can be sensed. When a user touches predetermined key buttons among the plurality of key buttons such that the key buttons contact their associated touchpad pieces in a state where a menu screen is displayed, the predetermined key buttons serve as navigation key buttons for changing a menu screen between main menus or shifting a highlight between submenus. Upon detecting a touch-drag for a plurality of key buttons in a menu mode, menu items displayed on the menu screen are sorted or highlight-scrolled according to a predetermined condition for the touch-dragged key button group.

### PRIORITY

This application claims the benefit under 35 U.S.C. §119(a) of an application entitled “User Interface Apparatus and Method” filed in the Korean Intellectual Property Office on Feb. 24, 2005 and assigned Serial No. 2005-15521, the entire contents of which are hereby incorporated by reference.

### BACKGROUND OF THE INVENTION

1. Field of the Invention

The present invention relates generally to a user interface apparatus and method, and in particular, to a user interface apparatus and method capable of using both a touchpad and a press-type keypad.

2. Description of the Related Art

In general, electronic devices such as a mobile phone, a game device and a navigation terminal include various keys (or buttons) such as Menu key, OK key, Select key, and so on.

For example, a mobile phone has a press-type keypad (hereinafter simply referred to as a “keypad”) in which 0, 1, . . . , 9, * and # keys are arranged in a 3×4 matrix. The keys are used to not only input Arabic numbers, but also Alphabets, Korean Alphabets and special characters. In addition to the alphanumeric keys, the mobile phone includes various function keys such as Call key, End key, Menu key, Search key, and so on. Further, the mobile phone may include navigation keys used for indicating Up, Down, Left and Right directions. The navigation keys are slow in response speed, because a user is required to press the keys to shift a highlight over menus.

For example, in the case of a Personal Digital Assistant (PDA) having a touchpad, a user can input data using a touch screen and a stylus pen. In a search mode, if the user touches the touchpad, the PDA recognizes that a key is pressed. In a cursor mode, the user can shift to a mouse pointer using the touchpad.

Neither the keypad nor the touchpad can implement a user interface apparatus that fully satisfies the user. In addition, in order to add new functions and new keys to follow the high-end and miniaturization trend of the terminal, it is necessary to solve the existing problems occurring in securing spaces for a key array, a menu screen, and an icon database. That is, there is a need for a cost-effective, simple user interface apparatus that can enable a user to input an increased number of inputs (e.g., user commands).

### SUMMARY OF THE INVENTION

It is, therefore, an object of the present invention to provide a user interface apparatus and method capable of extending a user interface range without increasing the number of physical key buttons, improving input sensitivity, and enabling fast menu selection.

According to one aspect of the present invention, there is provided a user interface apparatus that includes a panel having a plurality of key buttons, and a plurality of touchpad pieces, each of the plurality of touchpad pieces located under an associated key button such that a touch for an associated key button can be sensed.

According to another aspect of the present invention, there is provided a user interface method in a user interface apparatus including a plurality of key buttons and a plurality of touchpad pieces, each of the plurality of touchpad pieces located under an associated key button such that a touch for the associated key button can be sensed. The method includes determining if a menu screen for displaying thereon a main menu and its submenus is displayed; determining if an associated key button is touched in a state where the menu screen is displayed; displaying a previous main menu on the menu screen if a first associated key button is touched; displaying a next main menu on the menu screen if a second associated key button is touched; if a third associated key button is touched, shifting a highlight on the submenus displayed on the menu screen such that a previous menu item of a currently highlighted menu item is highlighted; and if a fourth associated key button is touched, shifting the highlight on the submenus displayed on the menu screen such that a next menu item of the currently highlighted menu item is highlighted.

### BRIEF DESCRIPTION OF THE DRAWINGS

The above and other objects, features and advantages of the present invention will become more apparent from the following detailed description when taken in conjunction with the accompanying drawings in which:

FIG. 1 is a perspective view of a folder-type mobile terminal with the folder open according to an embodiment of the present invention;

FIG. 2 is a cross-sectional view of FIG. 1 taken along a line A-A′;

FIG. 3 is a perspective view of a folder-type mobile terminal with the folder open according to another embodiment of the present invention;

FIG. 4 is a perspective view of a slide-type mobile terminal with the slider open according to a further embodiment of the present invention;

FIG. 5 is a block diagram illustrating a structure of a mobile phone according to an embodiment of the present invention;

FIGS. 6A and 6B are diagrams illustrating a first exemplary method for changing display of a menu screen in a mobile terminal according to an embodiment of the present invention;

FIGS. 7A, 7B, and 7C are diagrams illustrating a second exemplary method for changing display of a menu screen in a mobile terminal according to an embodiment of the present invention;

FIG. 8 is a flowchart illustrating a first exemplary method for changing display of a menu screen in a mobile terminal according to an embodiment of the present invention;

FIG. 9 is a flowchart illustrating a second exemplary method for changing display of a menu screen in a mobile terminal according to an embodiment of the present invention;

FIG. 10 is a flowchart illustrating a third exemplary method for changing display of a menu screen in a mobile terminal according to an embodiment of the present invention; and

FIG. 11 is a flowchart illustrating a fourth exemplary method for changing display of a menu screen in a mobile terminal according to an embodiment of the present invention.

### DETAILED DESCRIPTION OF EXEMPLARY EMBODIMENTS

Several exemplary embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for clarity and conciseness.

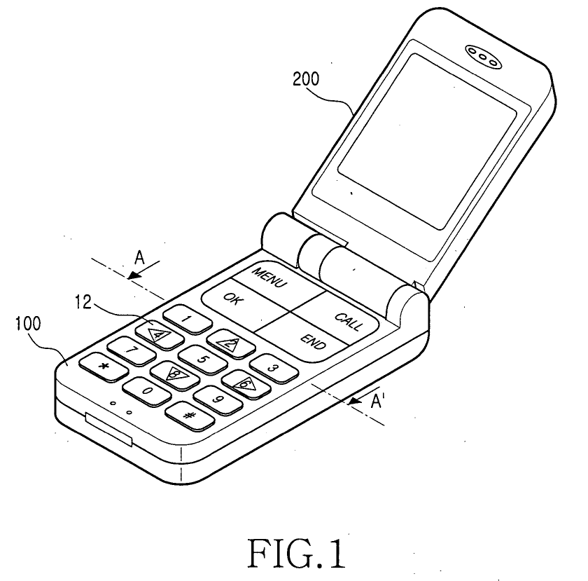

FIG. 1 is a perspective view of a folder-type mobile terminal with the folder open according to an embodiment of the present invention.

Referring to FIG. 1, reference numeral 100 denotes a body of a mobile terminal, and reference numeral 200 denotes a folder of the mobile terminal. The body 100 has 12 key buttons of 0, 1, . . . , 9, * and # key buttons arranged thereon in a 3×4 matrix, and 4 function key buttons of Menu, OK, Call and End key buttons. The 4 function key buttons are implemented in a touchpoint method using a touchpad. A touch pad as referred to throughout the disclosure is able to sense a touch of a key button not sufficient to trigger a key stroke. A key stroke is a push of a key button sufficient to be recognized as a key stroke on conventional keyboards or key pads.

Key buttons denoted by reference numeral 12 can be implemented with dome switches. The key buttons have their own touchpad pieces (not shown) arranged thereunder. A size of the touchpad pieces is determined such that they can sense a touch of their associated key buttons.

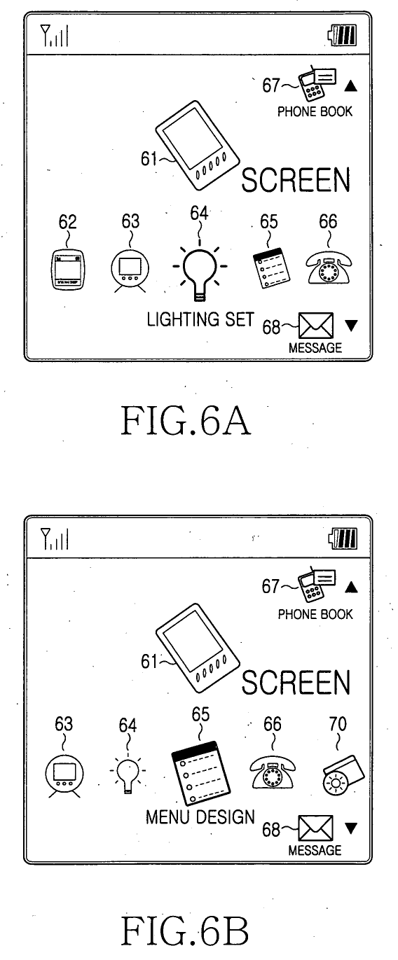

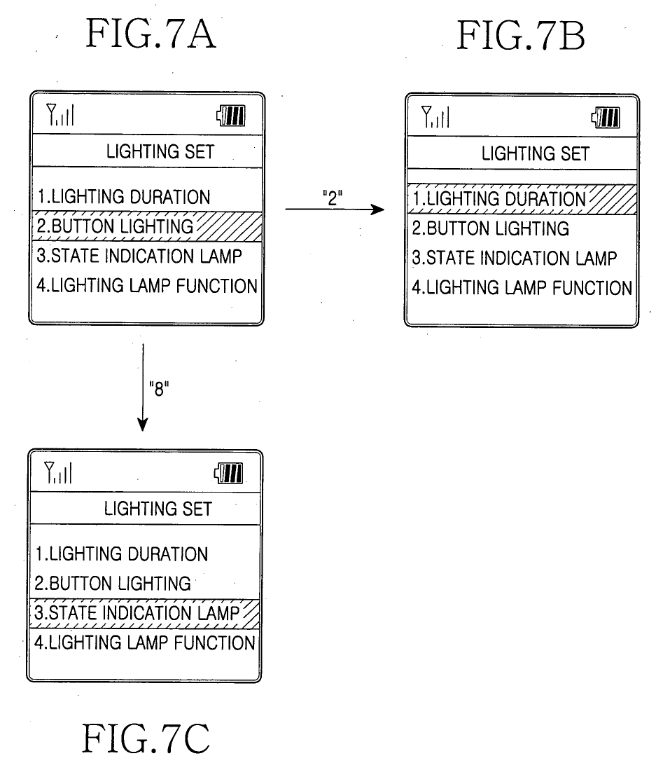

The numeric key buttons for 2, 4, 6 and 8 serve also as navigation key buttons for indicating Up, Left, Right and Down directions, respectively, only in a menu mode in which a menu screen is displayed. In this case, the key buttons are sensed in the touchpoint method. An exemplary use of the key buttons will be described in detail with reference to FIGS. 6A through 7C.

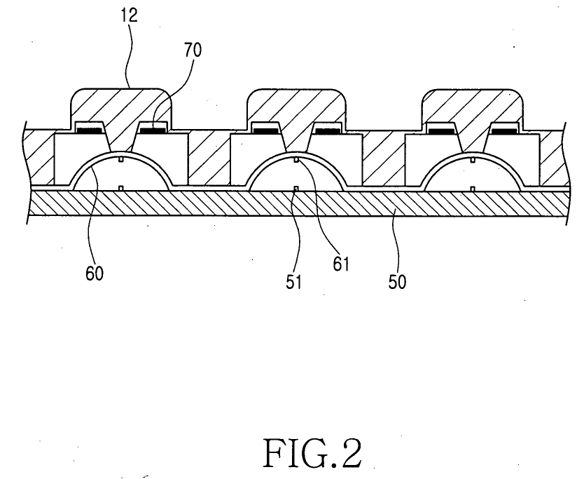

FIG. 2 is a cross-sectional view of FIG. 1 taken along a line A-A′.

Dome switches 60 for the key buttons 12 are prepared on a printed circuit board (PCB) 50. The dome switches 60 generate signals when contacts 51 of the PCB 50 make contact with contacts 61 of the dome switches 60. The key buttons 12 have touchpad pieces 70 with a capacitance sensor, mounted thereunder.

The combined structure of the key button and the touchpad pieces can sense various inputs through touch/drag interaction for the key buttons.

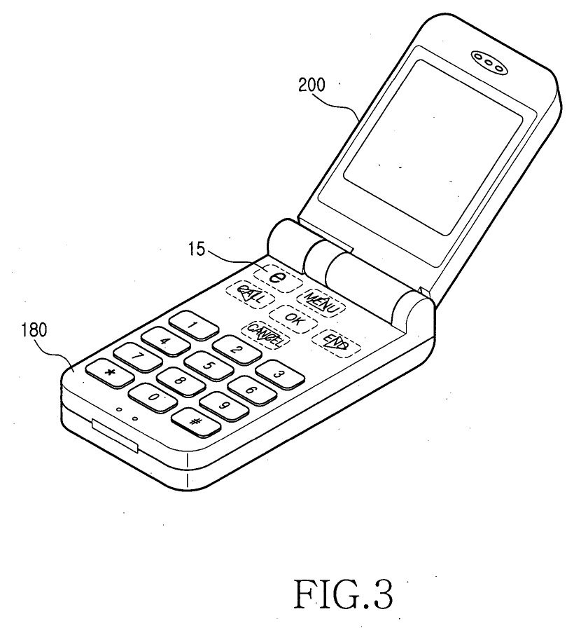

FIG. 3 is a perspective view of a folder-type mobile terminal with the folder open according to another embodiment of the present invention.

Referring to FIG. 3, reference numeral 180 denotes a body of a mobile terminal, and reference numeral 200 denotes a folder of the mobile terminal. The body 180 has 12 key buttons of 0, 1, . . . , 9, * and # key buttons arranged thereon in a 3×4 matrix, and 6 function key buttons of Menu, OK, Call, End, Cancel, and e key buttons.

The 6 function key buttons can be implemented so as to operate in a touchpoint method using either their individual touchpad pieces (indicated by dotted lines, but not actually seen) or a single touchpad. Alternatively, the function key buttons can be implemented with press-type key buttons.

The ‘e’-key button is used to access the Internet, run a web browser in the mobile terminal, and access a desired server. The Menu, Call, End and Cancel key buttons can serve also as navigation key buttons for indicating Up, Left, Right and Down directions, respectively, in addition to their own unique functions.

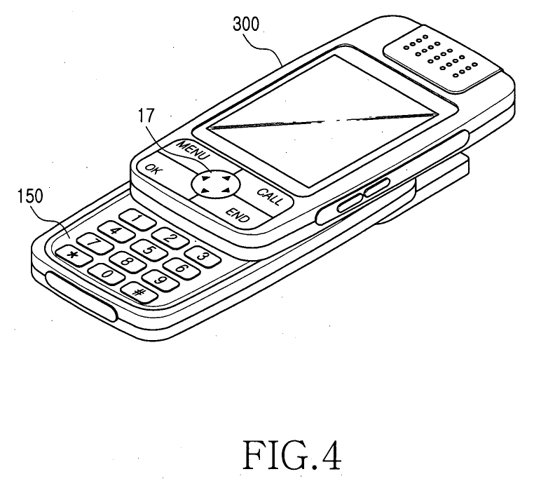

FIG. 4 is a perspective view of a slide-type mobile terminal with the slider open according to a further embodiment of the present invention.

Referring to FIG. 4, a body 150 is equal to the body 180 of FIG. 3 in terms of the structure of a keypad including 0, 1, . . . , 9, * and # key buttons. A slider 300 has 4 function key buttons of Menu, OK, Call and End key buttons, and a navigation key button 17. The navigation key button 17 is circular and interposed between the 4 function key buttons.

The navigation key button 17 and the 4 function key buttons can be implemented so as to operate in a touchpoint method by installing thereunder a touchpad (not shown) with capacitance sensors. In the navigation key button 17, four touch points (←, ↑, →, ↓) perform a navigation function.

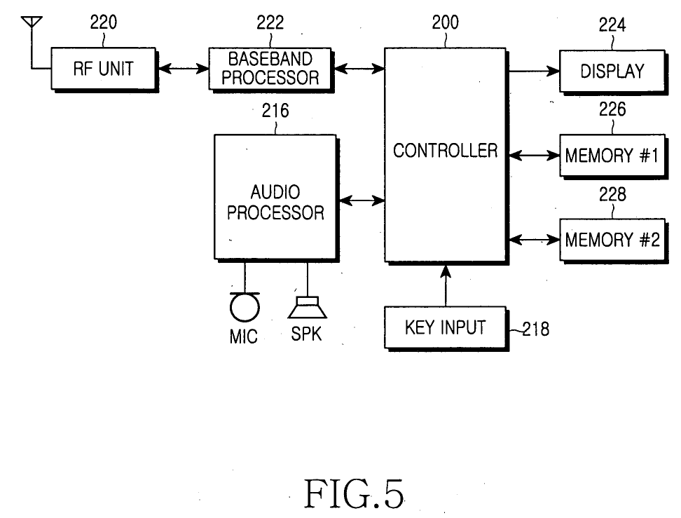

FIG. 5 is a block diagram illustrating a structure of a mobile phone according to an embodiment of the present invention.

A user interface apparatus according to an embodiment of the present invention can be used for a mobile terminal such as a mobile phone or a complex terminal having not only a call function but also at least one other function such as digital camera, digital multimedia broadcasting (DMB), MP3 and telematics functions, for an electronic diary, and for a game device.

The user interface apparatus according to an embodiment of the present invention will be described herein with reference to the structure of the mobile phone illustrated in FIG. 5.

Referring to FIG. 5, after completion of origination or termination, a controller 200 stores a related phone number in a phone book in a second memory 228. The origination or termination is for transmission or reception of a voice call, and/or short message service (SMS), multimedia, instant and E-mail messages. Upon receiving a menu display command for phone numbers, MP3 music, SMS messages or E-mails from a user, the controller 200 searches the second memory 228 for the corresponding contents and provides the searched contents to a display 224. The controller 200 can read menu items to be displayed on the display 224 from the second memory 228 and sort the menu items in a particular order according to a corresponding command.

A first memory 226, comprised of a read only memory (ROM) and a random access memory (RAM), stores programs for performing unique operations of the mobile phone, and their associated data.

The second memory 228 stores therein menu display information for phone book, MP3 music, SMS messages or E-mails, and their associated data.

A radio frequency (RF) unit 220 includes an RF transmitter for frequency-up-converting and amplifying a transmission signal and an RF receiver for low-noise-amplifying and frequency-down-converting a received signal. For signal transmission, the RF unit 220 converts an input baseband signal into an intermediate frequency (IF) signal, converts the IF signal into an RF signal and transmits the RF signal to a base station via an antenna. For signal reception, the RF unit 220 converts an RF signal received from the base station via the antenna into an IF signal, and converts the IF signal into a baseband signal. A baseband processor 222, interconnected between the RF unit 220 and the controller 200, performs baseband signal processing. An audio processor 216 performs Pulse Code Modulation (PCM) on an electric signal converted from a user's voice by a microphone MIC, and provides the PCM-modulated signal to the controller 200. Further, the audio processor 216 converts a PCM signal into an electric signal and then a speaker SPK outputs an audible signal.

A key button input unit 218 and the display 224 constitutes a user interface. The key button input unit 218 includes a plurality of key buttons, such as alphanumeric key buttons for inputting phone numbers and characters, function key buttons for inputting various functions, and navigation key buttons, all of which are shown in FIGS. 1, 3 and 4. If a user touches a particular key button or touch-drags a plurality of key buttons, the key button input unit 218 senses the touch or the touch-drag and provides a corresponding input (e.g., a command or actual data) to the controller 200. The display 224 can be implemented with a liquid crystal display (LCD). The display 224, under the control of the controller 200, displays not only the current state of the mobile phone, but also menu screens for phone numbers, MP3 music, SMS messages or E-mails.

FIGS. 6A and 6B are diagrams illustrating a first exemplary method for changing the display of a menu screen in a mobile terminal according to an embodiment of the present invention.

FIG. 6A illustrates a menu screen that displays an icon 61 for a main menu ‘Screen’ last used by a user after entering a menu mode using a Menu key button, and icons 62 through 66 (Normal Screen 62, Background Screen Select 63, Lighting Set 64, Menu Design 65 and Dial Design 66) for its submenus. A Phone Book menu indicated by an icon 67 and a Message menu indicated by an icon 68 are brother menus of the Screen menu indicated by the icon 61, and they are a previous main menu and a next main menu of the Screen menu, respectively. As illustrated, the Lighting Set icon 64 is located in the center of the five icons 62 through 66, and is displayed larger (or highlighted) with ‘Lighting Set’ displayed thereunder to indicate that the corresponding icon is selected. Although not illustrated, if the user touches a ‘2’-key button, i.e. an up-key button, in the state where the menu screen shown in FIG. 6A is displayed, the Phone Book menu will replace the Screen menu, and if the user touches an ‘8’-key button, i.e. a down-key button, the Message menu will replace the Screen menu. The user can identify a previous main menu and a next main menu at the sight of the icons 67 and 68.

FIG. 6B illustrates the menu screen of FIG. 6A, in which if a user touches a ‘6’-key button, a next item is highlighted. In this case, the ‘6’-key button serves as a Right key button (or Right-direction key button) as shown in FIG. 1, by way of example. Compared with the menu screen shown in FIG. 6A, the menu screen shown in FIG. 6B is displayed such that the Normal Screen icon 62 that was located in the leftmost position among the submenus has disappeared and a Screen Lighting icon 70 has newly appeared in the rightmost position. Further, the Menu Design icon 65 is located in the center and displayed larger (or highlighted) with ‘Menu Design’ displayed thereunder.

FIGS. 7A through 7C are diagrams illustrating a second exemplary method for changing display of a menu screen in a mobile terminal according to an embodiment of the present invention.

FIGS. 7A and 7C are diagrams illustrating a menu screen in which submenus are displayed when the Lighting Set menu is selected in the menu screen of FIG. 6A. Specifically, FIG. 7A illustrates a menu screen in which a main menu ‘Lighting Set’ and its submenus (1.Lighting Duration, 2.Button Lighting, 3.State Indication Lamp, and 4.Lighting Lamp Function) are displayed. As illustrated, a highlight is currently located in an item ‘2.Button Lighting’. FIG. 7B illustrates a menu screen in which the highlight is shifted to a previous item ‘1.Lighting Duration’ of the current item ‘2.Button Lighting’ when the user touches a ‘2’-key button, i.e. an up-key button, in the menu screen shown in FIG. 7A. FIG. 7C illustrates a menu screen in which the highlight is shifted to a next item ‘3.State Indication Lamp’ of the current item ‘2.Button Lighting’ when the user touches an ‘8’-key button, i.e. a down-key button, in the menu screen shown in FIG. 7A. In the menu screen shown in FIGS. 7A through 7C, because the highlight is shifted only in the up/down direction, only the up/down navigation key buttons (‘2’-key button and ‘8’-key button) are used and the left/right navigation key buttons (‘4’-key button and ‘6’-key button) are unused.

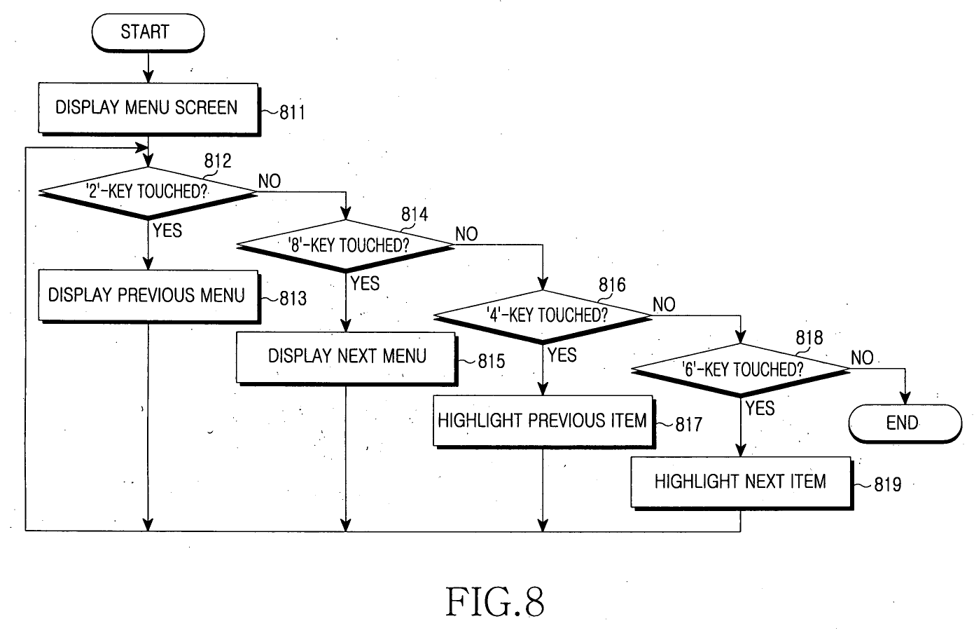

FIG. 8 is a flowchart illustrating a first exemplary method for changing display of a menu screen in a mobile terminal according to an embodiment of the present invention.

Referring to FIG. 8, a mobile terminal displays in step 811 a menu screen on a display, as shown in FIG. 6A, by way of example. In FIG. 6A, an icon 61 indicates a main menu ‘Screen’, and icons 62 through 66 indicate submenus of the main menu ‘Screen’.

The mobile terminal determines in step 812 if a user has touched a ‘2’-key button. If the user has touched the ‘2’-key button, the mobile terminal displays in step 813 a previous main menu (for example, Phone Book menu in FIG. 6A).

However, if the user has not touched the ‘2’-key button, the mobile terminal determines in step 814 if the user has touched an ‘8’-key button. If the user has touched the ‘8’-key button, the mobile terminal displays in step 815 a next main menu (for example, Message menu in FIG. 6A).

If the user has not touched the ‘8’-key button, the mobile terminal determines in step 816 if the user has touched a ‘4’-key button. If the user has touched the ‘4’-key button, the mobile terminal shifts a previous item (for example, Menu Design item 65 in FIG. 6A) to the center and highlights the previous item in step 817, as shown in FIG. 6B, by way of example.

However, if the user has not touched the ‘4’-key button, the mobile terminal determines in step 818 if the user has touched a ‘6’-key button. If the user has touched the ‘6’-key button, the mobile terminal shifts a next item (for example, Background Screen Select item 63 in FIG. 6A) to the center and highlights the next item in step 819.

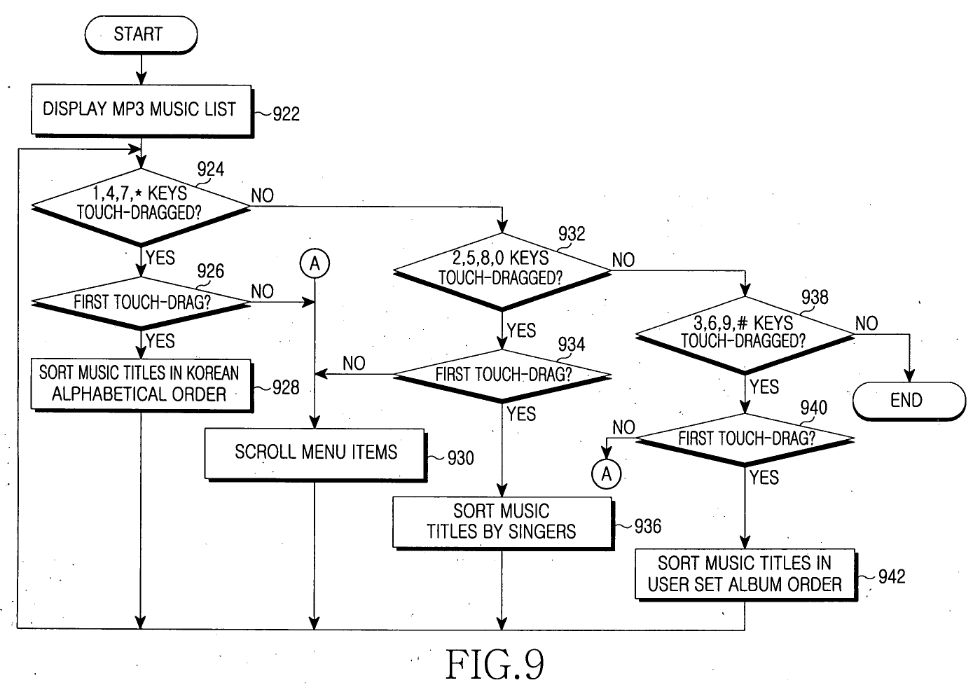

FIG. 9 is a flowchart illustrating a second exemplary method for changing display of a menu screen in a mobile terminal according to an embodiment of the present invention.

Referring to FIG. 9, a mobile terminal displays in step 922 an MP3 music list on a display in a predetermined order The mobile terminal determines in step 924 if a user has touch-dragged ‘1’-column key buttons of 1, 4, 7 and * key buttons. If the user has touch-dragged the ‘1’-column key buttons of 1, 4, 7 and * key buttons, the mobile terminal determines in step 926 if the touch-drag is a first touch-drag. If the user has first touch-dragged the 1, 4, 7 and * key buttons, the mobile terminal sorts in step 928 the displayed music titles in Korean alphabetical order. Herein, the “first touch-drag” means a touch-drag made first when the 1, 4, 7 and * key buttons are continuously touch-dragged several times. If the user has not first touch-dragged the 1, 4, 7 and * key buttons, the mobile terminal scrolls menu items by shifting a highlight in step 930. For example, the mobile terminal scrolls up/down the sorted MP3 music titles.

If it is determined in step 924 that the user has not touch-dragged the 1, 4, 7 and *-key buttons, the mobile terminal determines in step 932 if the user has touch-dragged ‘2’-column key buttons of 2, 5, 8 and 0 key buttons. If the user has touch-dragged the 2, 5, 8 and 0 key buttons, the mobile terminal determines in step 934 if the touch-drag is a first touch-drag. If the user has first touch-dragged the 2, 5, 8 and 0 key buttons, the mobile terminal sorts in steps 936 the displayed music titles by singers. Herein, the “first touch-drag” means a touch-drag made first when the 2, 5, 8 and 0 key buttons are continuously touch-dragged several times. If the user has not first touch-dragged the 2, 5, 8 and 0 key buttons, the mobile terminal scrolls menu items by shifting a highlight in step 930. For example, the mobile terminal scrolls up/down the displayed MP3 music titles sorted by singers, and sorts the displayed music titles of the same singer in Korean alphabetical order.

However, if it is determined in step 932 that the user has not touch-dragged ‘2’-column key buttons of 2, 5, 8 and 0 key buttons, the mobile terminal determines in step 938 if the user has touch-dragged ‘3’-column key buttons of 3, 6, 9 and # key buttons. If the user has touch-dragged the 3, 6, 9 and # key buttons, the mobile terminal determines in step 940 if the touch-drag is a first touch-drag. If the user has first touch-dragged the 3, 6, 9 and # key buttons, the mobile terminal sorts in step 942 the displayed music titles in user set album order (in the case where the user makes his/her own albums by storing designed music files in individual folders). Herein, the “first touch-drag” means a touch-drag made first when the 3, 6, 9 and # key buttons are continuously touch-dragged several times. If the user has not first touch-dragged the 3, 6, 9 and # key buttons, the mobile terminal scrolls menu items by shifting a highlight in step 930. For example, if the user touch-drags the 2, 5, 8 and 0 key buttons one time and touch-drags the 1, 4, 7 and * key buttons one time in the state where initial MP3 music titles are displayed on the display, the mobile terminal sorts the displayed MP3 music titles by singers and resorts the MP3 music titles in Korean alphabetical order.

Although only the three types of touch-drags for the three column key buttons of the ‘1’ through ‘3’-column key buttons are defined herein for a keypad in which 0, 1, . . . , 9, * and # key buttons are arranged in a 3×4 matrix, various modifications can be made by defining touch-drag key button groups in different ways and defining different touch-drag directions. For example, for the keypad in which 0, 1, . . . , 9, * and # key buttons are arranged in a 3×4 matrix, an embodiment of the present invention can define a maximum of seven touch-drags, including four row touch-drags for ‘1’-row key buttons of 1, 2 and 3 key buttons, a ‘4’-row key buttons of 4, 5 and 6 key buttons, a ‘7’-row key buttons of 7, 8 and 9 key buttons, and a ‘*’ row key buttons of *, 0 and # key buttons in addition to the three column touch-drags. The embodiment of the present invention can be applied not to the 3×4-matrix keypad but also to any other keypads including quarter keypad.

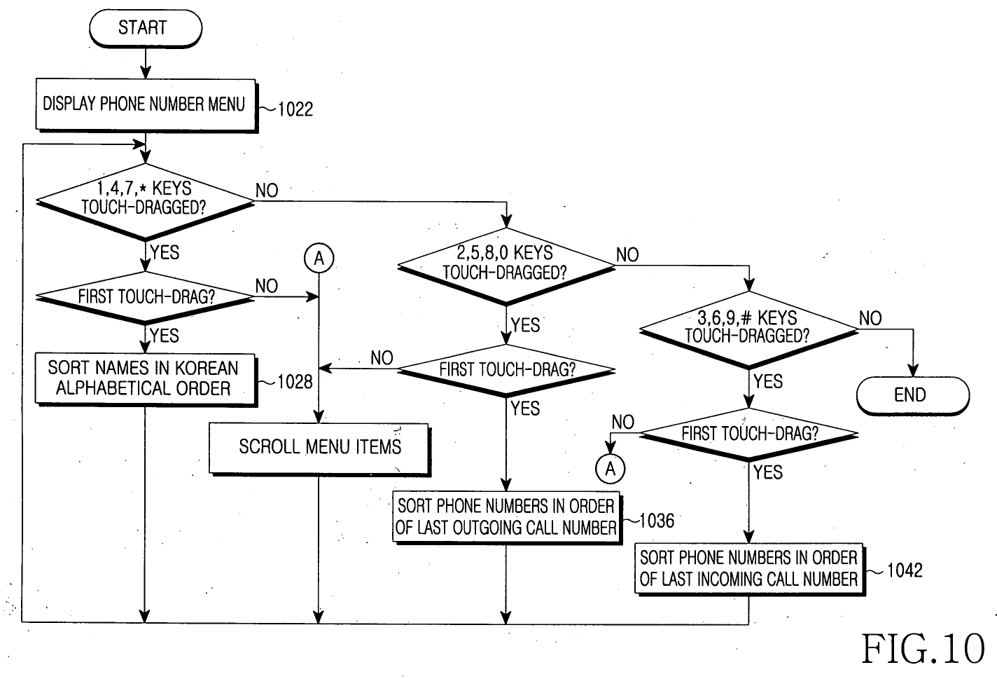

FIG. 10 is a flowchart illustrating a third exemplary method for changing display of a menu screen in a mobile terminal according to an embodiment of the present invention.

The third method of FIG. 10 is similar in operation to the second method of FIG. 9 except that a Phone Book menu is displayed on a display, and definitions of touch-drags for ‘1’-column key buttons of 1, 4, 7 and * key buttons, a ‘2’-column key buttons of 2, 5, 8 and 0 key buttons, and ‘3’-column key buttons of 3, 6, 9 and # key buttons are given in different ways.

If a user touch-drags the ‘1’-column key buttons of 1, 4, 7 and * key buttons in the state where a menu screen for the Phone Book menu is displayed in step 1022, a mobile terminal sorts step 1028 the displayed names of phone numbers in Korean alphabetical order. If the user touch-drags the ‘2’-column key buttons of 2, 5, 8 and 0 key buttons, the mobile terminal sorts in step 1036 the displayed phone numbers in the order of the last outgoing call number. If the user touch-drags the ‘3’-column key buttons of 3, 6, 9 and # key buttons, the mobile terminal sorts in step 1042 the displayed phone numbers in the order of the last incoming call number.

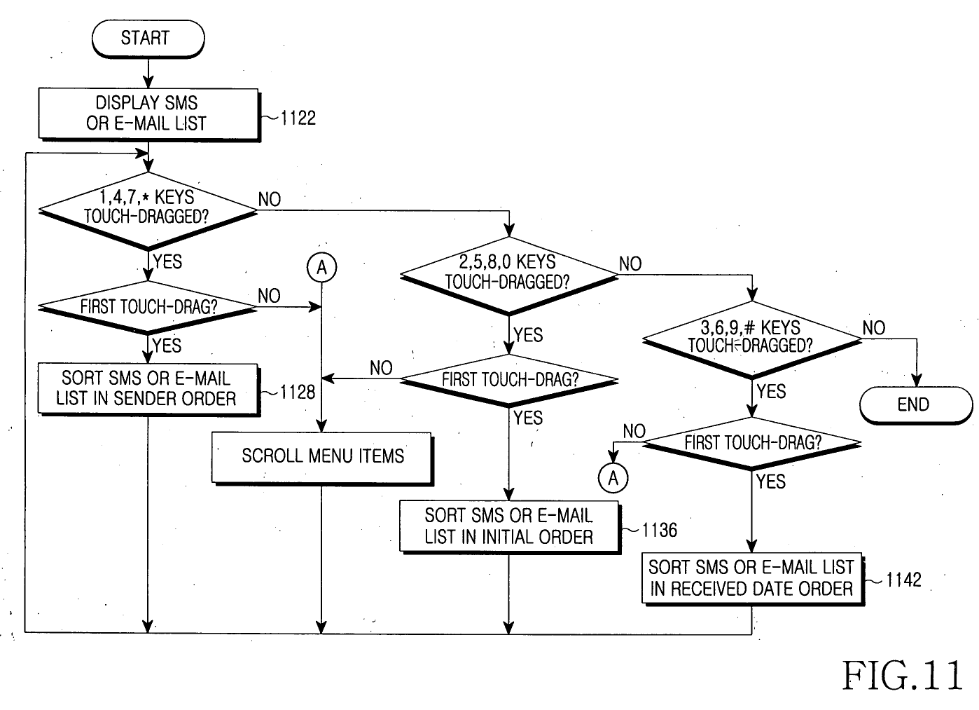

FIG. 11 is a flowchart illustrating a fourth exemplary method for changing display of a menu screen in a mobile terminal according to an embodiment of the present invention.

The fourth method of FIG. 11 is similar in operation to the second method of FIG. 9 except that an SMS or E-mail list is displayed on a display, and definitions of touch-drags for ‘1’-column key buttons of 1, 4, 7 and * key buttons, a ‘2’-column key buttons of 2, 5, 8 and 0 key buttons, and ‘3’-column key buttons of 3, 6, 9 and # key buttons are given in different ways.

If a user touch-drags the ‘1’-column key buttons of 1, 4, 7 and * key buttons in the state where an SMS or E-mail list is displayed in step 1122, a mobile terminal sorts in step 1128 the displayed SMS or E-mail list in the order of sender‘s name. If the user touch-drags the ‘2’-column key buttons of 2, 5, 8 and 0 key buttons, the mobile terminal sorts in step 1136 the displayed SMS or E-mail list in the order of initials of the SMS messages or E-mails. If the user touch-drags the ‘3’-column key buttons of 3, 6, 9 and # key buttons, the mobile terminal sorts in step 1142 the displayed SMS or E-mail list in received date order.

Although an embodiment of the present invention sorts the displayed items in Korean alphabetical order by way of example, an alternative embodiment of the present invention can sort the displayed items in alphabetical order of any other language. The embodiment of the present invention can define the touch-drags not only in the column (or up-to-down) direction, but also in the row (or left-to-right) direction.

As can be understood from the foregoing description, an embodiment of the present invention combines press-type key buttons with a touchpoint method, thereby enabling fast menu selection and increasing input sensitivity as compared with when only the press-type key buttons are used. In addition, the embodiment of the present invention predefines column and row touch-drags for a matrix keypad as predetermined inputs, contributing to an increase in user interface range without an increase in number of physical key buttons.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. An apparatus, comprising:
a plurality of key buttons; and
a plurality of touchpad pieces, each touch pad being located under one of the plurality of key buttons and adapted to sense a touch of a key button; and a controller adapted to receive an input corresponding to the touch of the key button and change a display of a menu screen based on the input.

2. The user interface apparatus of claim 1, wherein the plurality of key buttons are adapted to serve as navigation key buttons for at least one of switching between a plurality of main menus and shifting a highlight on submenus of a main menu.

3. The user interface apparatus of claim 2, wherein a main menu and its submenus are displayed in the form of icons on a same menu screen, the submenu icons are horizontally arranged under the main menu icon, and a selected submenu icon is highlighted so that the selected submenu icon can be distinguished from the other submenu icons.

4. The user interface apparatus of claim 2, wherein the submenus are displayed in the form of icons, wherein each time one of the plurality of the key buttons corresponding to a right-direction key button is touched, all of the submenu icons are shifted to the left and, wherein each time one of the plurality of the key buttons corresponding to a left-direction key button is touched, all of the submenu icons are shifted to the right.

5. The user interface apparatus of claim 1, wherein each touch pad is adapted to sense a touch of a key button, said touch being a force less than the force sufficient to trigger a key stroke.

6. The user interface apparatus of claim 1, wherein the plurality of key buttons have 0, 1, . . . , 9, * and # key buttons arranged thereon in a 3×4 matrix.

7. The user interface apparatus of claim 1, wherein the plurality of key buttons have at least one function key button implemented with a touchpad.

8. The user interface apparatus of claim 7, wherein the at least one function key button comprises ‘menu’, ‘OK’, ‘call’, ‘end’ and ‘cancel’ key buttons.

9. The user interface apparatus of claim 1, wherein the plurality of key buttons are on a body of a mobile terminal.

10. A user interface apparatus, comprising:
a plurality of key buttons found in an m×n matrix; and
a plurality of touchpad pieces, each of the plurality of touchpad pieces located under an associated key button and situated such that a touch of an associated key button can be sensed; and
a controller for, upon detecting a first touch-drag for m or n number of key buttons in a column or row direction in a menu mode, sorting items displayed on a menu screen according to a predetermined condition for the touch-dragged key button group.

11. The user interface apparatus of claim 10, wherein the maximum number of the predetermined conditions is equal to a sum, m+n, of the number, m, of columns and the number, n, of rows.

12. The user interface apparatus of claim 10, wherein if a touch-drag for the same key button group is repeatedly sensed, the controller highlight-scrolls menu items.

13. The user interface apparatus of claim 10, further comprising:
a memory for storing MP3 music files; and
a display for displaying a menu screen for the MP3 music files,
wherein the controller sorts music titles displayed on the display in alphabetical order upon detecting a first touch-drag for x-row or y-column key buttons in an MP3 play mode, wherein x=1, . . . ,m, and y=1, . . . ,n.

14. The user interface apparatus of claim 10, further comprising:
a memory for storing MP3 music files; and
a display for displaying a menu screen for the MP3 music files,
wherein the controller sorts music titles displayed on the display by artist upon detecting a first touch-drag for x-row or y-column key buttons in an MP3 play mode, wherein x=1, . . . ,m, and y=1, . . . ,n.

15. The user interface apparatus of claim 10, further comprising:
a memory for storing MP3 music files; and
a display for displaying a menu screen for the MP3 music files,
wherein the controller sorts music titles displayed on the display in user set album order upon detecting a first touch-drag for x-row or y-column key buttons in an MP3 play mode, wherein x=1, . . . ,m, and y=1, . . . ,n.

16. The user interface apparatus of claim 10, further comprising:
a memory for storing phone numbers; and
a display for displaying a menu screen for the phone numbers,
wherein the controller sorts subscriber names mapped to the phone numbers stored in the memory, displayed on the display, in alphabetical order upon detecting a first touch-drag for x-row or y-column key buttons in a phone number display mode, wherein x=1, . . . ,m, and y=1, . . . ,n.

17. The user interface apparatus of claim 10, further comprising:
a memory for storing phone numbers; and
a display for displaying a menu screen for the phone numbers,
wherein the controller sorts the phone numbers stored in the memory, displayed on the display, in the order of last outgoing call number upon detecting a first touch-drag for x-row or y-column key buttons in a phone number display mode, wherein x=1, . . . ,m, and y=1, . . . ,n.

18. The user interface apparatus of claim 10, further comprising:
a memory for storing phone numbers; and
a display for displaying a menu screen for the phone numbers,
wherein the controller sorts the phone numbers stored in the memory, displayed on the display, in the order of last incoming call number upon detecting a first touch-drag for x-row or y-column key buttons in a phone number display mode, wherein x=1, . . . ,m, and y=1, . . . ,n.

19. The user interface apparatus of claim 10, further comprising:
a memory for storing short message service (SMS) messages; and
a display for displaying a menu screen for an SMS message list,
wherein the controller sorts the SMS message list displayed on the display in sender order upon detecting a first touch-drag for x-row or y-column key buttons in an SMS message display mode, wherein x=1, . . . ,m, and y=1, . . . ,n.

20. The user interface apparatus of claim 10, further comprising:
a memory for storing SMS messages; and
a display for displaying a menu screen for an SMS message list,
wherein the controller sorts the SMS message list displayed on the display in the order of initials of the SMS messages upon detecting a first touch-drag for x-row or y-column key buttons in an SMS message display mode, wherein x=1, . . . ,m, and y=1, . . . ,n.

21. The user interface apparatus of claim 10, further comprising:
a memory for storing SMS messages; and
a display for displaying a menu screen for an SMS message list,
wherein the controller sorts the SMS message list displayed on the display in received date order upon detecting a first touch-drag for x-row or y-column key buttons in an SMS message display mode, wherein x=1, . . . ,m, and y=1, . . . ,n.

22. The user interface apparatus of claim 10, further comprising:
a memory for storing E-mails; and
a display for displaying a menu screen for an E-mail list,
wherein the controller sorts the E-mail list displayed on the display in sender order upon detecting a first touch-drag for x-row or y-column key buttons in an E-mail display mode, wherein x=1, . . . ,m, and y=1, . . . ,n.

23. The user interface apparatus of claim 10, further comprising:
a memory for storing E-mails; and
a display for displaying a menu screen for an E-mail list,
wherein the controller sorts the E-mail list displayed on the display in order of initials of the E-mails upon detecting a first touch-drag for x-row or y-column key buttons in an E-mail display mode, wherein x=1, . . . ,m, and y=1, . . . ,n.

24. The user interface apparatus of claim 10, further comprising:
a memory for storing E-mails; and
a display for displaying a menu screen for an E-mail list,
wherein the controller sorts the E-mail list displayed on the display in received date order upon detecting a first touch-drag for x-row or y-column key buttons in an E-mail display mode, wherein x=1, . . . ,m, and y=1, . . . ,n.

25. The user interface apparatus of claim 10, further comprising at least one function key button that comprises an independent touchpad piece.

26. The user interface apparatus of claim 25, wherein when one of four function key buttons are touched in a state where the menu screen is displayed, the four function key buttons serve as navigation key buttons indicating up, left, right and down directions.

27. The user interface apparatus of claim 26, wherein the controller sorts particular menu items displayed on the menu screen according to a predetermined condition upon detecting a first touch-drag for key buttons in row or column direction in a state where the menu screen is displayed.

28. The user interface apparatus of claim 27, wherein if a touch-drag for the same key button group is repeated, the controller highlight-scrolls the menu items.

29. The user interface apparatus of claim 26, further comprising a function key button used for performing automatic Internet access upon detecting its touch, the function key button comprising an independent touchpad piece.

30. The user interface apparatus of claim 29, wherein the function key button comprises ‘menu’, ‘call’, ‘end’ and ‘cancel’ key buttons, and further comprises an ‘OK’ key button comprising an independent touchpad piece.

31. The user interface apparatus of claim 25, wherein the plurality of key buttons and the touchpad pieces for the function key buttons are mounted on a body of a mobile terminal.

32. The user interface apparatus of claim 10, further comprising navigation key buttons for controlling up, left, right and down directions, the navigation key buttons being implemented with a touchpad.

33. The user interface apparatus of claim 32, further comprising at least one function key button implemented with a touchpad.

34. The user interface apparatus of claim 32, wherein said navigation key buttons are mounted on a slider of a mobile terminal.

35. A user interface method in an apparatus including a plurality of key buttons and a plurality of touchpad pieces, each of the plurality of touchpad pieces located under one of the plurality of key buttons and adapted for sensing a touch for the corresponding key button, the method comprising the steps of:
determining if one of the plurality of the key buttons is touched in a state controlled by a controller of the apparatus, where a menu screen is displayed in the state;
displaying a previous main menu on the menu screen if a first key button among the associated key buttons is touched;
displaying a next main menu on the menu screen if a second key button among the associated key buttons is touched;
if a third key button among the associated key buttons is touched, shifting a highlight on the submenus displayed on the menu screen such that a previous menu item of a currently highlighted menu item is highlighted; and
if a fourth key button among the associated key buttons is touched, shifting the highlight on the submenus displayed on the menu screen such that a next menu item of the currently highlighted menu item is highlighted.

36. The user interface method of claim 35, wherein the main menu and the submenus are displayed in the form of icons, the submenu icons are horizontally arranged under the main menu icon, and a selected submenu icon is highlighted so that the selected submenu icon can be distinguished from the other submenu icons.

37. The user interface method of claim 35, wherein the main menu and the submenus are displayed in the form of icons, wherein each time the third key button is touched, the submenu icons are shifted left such that an icon in the leftmost position is no longer displayed and a new submenu icon is displayed in the rightmost position, and wherein each time the fourth key button is touched, the submenu icons are shifted right such that an icon in the rightmost position is no longer displayed and a new submenu icon is displayed in the leftmost position.

38. The user interface method of claim 36, wherein the main menu and the submenus are displayed in the form of icons, wherein each time the third key button is touched, the submenu icons are shifted left such that an icon in the leftmost position is no longer displayed and a new submenu icon is displayed in the rightmost position, and wherein each time the fourth key button is touched, the submenu icons are shifted right such that an icon in the rightmost position is no longer displayed and a new submenu icon is displayed in the leftmost position.

39. The user interface method of claim 36, further comprising the steps of:
displaying a selected one of the submenu icons on the menu screen;
shifting the highlight to a previous menu item of the currently highlighted menu item if the first key button is touched; and
shifting the highlight to a next menu item of the currently highlighted menu item if the second key button is touched.

40. A user interface method in an apparatus including a plurality of key buttons and a plurality of touchpad pieces, each of the plurality of touchpad pieces located under a key button and adapted to sense a touch of the key button, the method comprising the steps of:
sensing a touch of the key button with the corresponding touchpad;
determining, in a menu mode, if a plurality of key buttons are touch-dragged in a row or column direction; and
upon detecting the touch-drag, controlling a function of the apparatus.

41. The user interface method of claim 40, further comprising the step of scrolling a highlight on menu items, if a touch-drag is sensed.

42. The user interface method of claim 40, further comprising the steps of:
determining if one of the plurality of key buttons is touched in a state where a menu screen is displayed;
displaying a previous main menu on the menu screen if a first key button among the associated key buttons is touched;
displaying a next main menu on the menu screen if a second key button among the associated key buttons is touched;
shifting a highlight to a previous menu item of a currently highlighted submenu if a third key button among the plurality of key buttons is touched; and
shifting the highlight to a next menu item of the currently highlighted submenu if a fourth key button among the plurality of key buttons is touched.

43. The user interface apparatus of claim 1, wherein each touch pad is adapted to sense a touch of a key button, said touch being of a force less than a force sufficient to trigger a key stroke.
